(19) United States
(12) Patent Application Publication
(10) Pub. No.: US 2009/0168981 A1
(43) Pub. Date: Jul. 2, 2009

(54) Apparatus and Methods for Managing Communication between Parties

(75) Inventors: David Johnson, Elmsworth (GB); Anthony Waters, Maidenhead (GB); William Hern, Reading (GB); John Storrie, Maidenhead (GB)

Correspondence Address: BARNES & THORNBURG LLP, P.O. BOX 2786, CHICAGO, IL, 60690-2786, US

(73) Assignee: NORTEL NETOWRKS LIMITED, St. Laurent (CA)

(21) Appl. No.: 11/964,753

(22) Filed: Dec. 27, 2007

(51) Int. Cl. H04M 15/00

(52) U.S. Cl. 379/114.14

(57) ABSTRACT

Increasing use is being made of XML procedure calls to control and integrate telecommunications networks with other IT equipment. XML messages are verbose and include information which is not required merely to monitor activity in the network for purposes such as billing and authentication. The use of XPath or XQuery operations allow the XML messages to be dynamically and quickly analysed and filtered for relevant information.

### BACKGROUND OF THE INVENTION

This invention relates to methods and apparatus for monitoring and controlling activity in a telecommunications network. It relates in particular to telecommunications networks including so-called “web services” which are controlled using extensible mark up language (XML)-based procedure calls.

Telecommunications systems are becoming increasingly integrated with other IT systems and thus there is an increasing need to provide common control interfaces which may be used across platforms. Typically the control interface is based on the transmission of XML text portions. These portions may be used to activate functions in telecommunications devices using so-called “remote procedure calls”. Typically the XML remote procedure calls are carried over a web application protocol such as HTTP or HTTPS. In this way the procedure calls may readily be issued through a web interface and stand a very good chance of passing through most firewalls; common examples of this type of functionality being a “click to call” link on a website which sets up a telephone call or “click to SMS” which initiates the sending of an SMS or “text” message.

The procedure call is received by a “web service” device in the network which then interprets the XML and carries out commands contained therein.

Typical examples of the XML remote procedure call technology are SOAP (service oriented architecture protocol or simple object access protocol) which allows XML to be transported across Internet application protocols including but not limited to the web protocols based on HTTP, and XML-RPC which uses HTTP as a transport protocol.

Whilst the use of XML procedure calls has become largely standardised in the web serving environment, their use is somewhat inefficient. This is because XML although conveniently human readable is consequently less compact than other middleware technologies such as CORBA. The verboseness of XML creates penalties in terms of the cost of processing the procedure calls and also transmitting those calls.

This penalty becomes particularly apparent when it is necessary to monitor activity in the network, for example for authentication or billing purposes. In these situations, it is rarely necessary to decode the complete procedure call simply to determine whether a user is authorised to carry out an activity or simply to make an appropriate charge to the user for using a particular facility.

As integration of telecommunications systems with other systems progresses, this problem of monitoring activity in the network initiated and controlled by XML procedure calls, will become more acute.

### BRIEF SUMMARY OF THE INVENTION

Typically the XML procedure calls which cause activity to be carried out in the network follows a path in a general flow from a user requesting the activity to a web services device or gateway which is able to carry out the activity. As a first step, the XML procedure call is intercepted before reaching the web services device. At this point it might be possible to parse the entire call but this is costly in terms of time and processing power and would yield a significant volume of data which is not required for activities such as billing and authentication. Thus in the present invention, the procedure call is analysed using database type queries such as XPath or XQuery in order to isolate just those parts of the procedure call which are relevant for the activity being monitored.

In a first aspect, the invention provides monitoring apparatus for a telecommunications network including XML query means arranged to extract predetermined fragments of data from XML procedure calls passing through the network and processing means arranged to take action based on the extracted data fragments.

For example, in an authentication scenario, authentication apparatus may include a user database which maps details of users to particular activities which the respective users are permitted to carry out in the network. The activities are typically described in the database in terms of matching XML call fragments. Using XPath or XQuery statements, the XML remote procedure call may be dissected to determine whether the relevant authentication portions are present and match those held in the user database. By placing the authentication means in the flow of the procedure call, the authentication means may be used to block unauthorised procedure calls thereby denying unauthorised users access to certain network features or functionality. The authentication apparatus may, for example, be used as a proxy between the user and the network or may be put at some central point such as within or adjacent to a load balancer placed in front of a plurality of web services gateways.

Similarly, in a billing scenario, activity may be monitored by dissecting XML procedure calls passing through a billing monitor. By using XPath or XQuery calls, chargeable activity may be identified in remote procedure calls and a billing record made appropriately. Alternatively, XML protocol calls may be stored for off-line analysis and billing.

In a second aspect the invention provides a method of monitoring activity in a telecommunications network comprising processing XML procedure calls flowing in the network and analysing only fragments of the procedure call using an XPath or XQuery operation.

In a third aspect the invention provides a telecommunications network including service provision means arranged to communicate using XML procedure calls, a user database containing details of users authorised to issue XML procedure calls to the service provision means and query means arranged to query the XML procedure calls to obtain data or text fragment from the procedure calls and comparison means to compare XML procedure calls with authorised procedure calls for particular users.

A fourth aspect of the invention provides a telecommunications network including service provision means arranged to communicate using XML procedure calls, a billing database containing details of charges for users and query means arranged to query the XML procedure calls to obtain data or text fragment from the procedure calls and comparison means to compare XML procedure calls with chargeable procedure calls for particular users and to update the billing database responsively.

A fifth aspect of the invention provides computer program which when executed on a suitable telecommunications network node causes the node to monitor activity in the telecommunications network by processing XML procedure calls flowing in the network and analysing only fragments of the procedure call using an XPath or XQuery operation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a schematic block diagram of a telecommunications network with an authentication scheme in accordance with the invention; and

FIG. 2 is a schematic block diagram of a telecommunications network with two alternative billing systems.

### DETAILED DESCRIPTION OF THE INVENTION

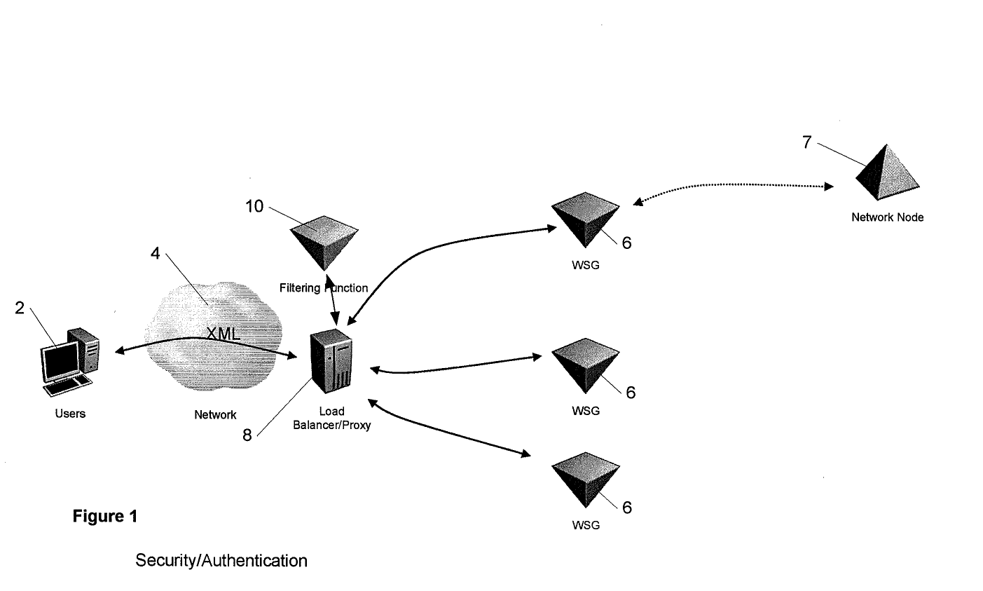

With reference to FIG. 1, users 2 are typically located remotely from the main network and may, for example, be connected to the network 4 via a web enabled device such as a computer or hand held device. Communication may, for example, be carried out over the Internet. Users 2 wish to interact with web services gateways 6 in order to use a telecommunications service offered by the web service gateways which may, for example, be carried out by a network node 7. This may, for example, be initiation of a telephone call directly from within a web browser.

In order to control the gateways 6, the users 2 issue commands either directly from the web browser application or via a web server using some form of XML procedure call such as SOAP. The XML procedure call is received by a load balancer 8 which is enhanced in one embodiment, by the addition of an XML proxy. The proxy communicates with a filter 10 (which may be included in the load balancer 8) which uses queries such as XPath or XQuery to analyse the procedure calls.

A typical such call is shown in the XML soap procedure call set out below.

<?xml version=″1.0″ encoding=“uff-8” ?>
<soapenv:Envelope
xmlns:soapenv=″http://schemas.xmlsoap.org/soap/envelope/″>
<soapenv:Header>
<wss:Security soapemv:mustUnderstand=″1″
xmlns:wss=″http://docs.oasis-open.org/wss/2004/01/oasis-200401-wss-
wssecurity-secext-1.0.xsd″>
<wss:UsernameToken wsu:Id=″XWSSGID-11435375577461001212174″
xmlns:wss=″http://docs.oasis-open.org/wss/2004/01/oasis-200401-wss-
wssecurity-secext-1.0.xsd″
xmlns:wsu=″http://docs.oasis-open.org/wss/2004/01/oasis-200401-wss-
wssecurity-utility-1.0.xsd″>

[symbol]

<wss:Password Type=″http://docs.oasis-open.org/wss/2004/01/oasis-200401-
wss-username-token-profile-
1.0#Password Digest″>$1$PNL8bBUR$5/v4/ueiQY7dW5U8DIzCZ0</wss:Password
>
<wss:Nonce EncodingType=″http://docs.oasis-open.org/wss/2004/01/oasis-
200401-wss-soap-message-security-
1.0#Base64Binary″>CiQxJFBOTDhiQIVSJDUvdjQvdWVpUVk3ZFc1VThEbHpD
WjAK</wss:Nonce>
<wsu:Created xmlns:wsu=″http://docs.oasis-open.org/wss/2004/01/oasis-
200401-wss-wssecurity-utility-1.0.xsd”>2007-03-01T11:15:18Z</wsu:Created>
</wss:UsernameToken>
</wss:Security>
</soapenv:Header>

[symbol]

[symbol]

[symbol]

[symbol]

<addresses xmlns=“”>tel:208511XXXX<addresses>
<senderName xmlns=“”>07958XXXXXX<senderName>
<message>Text of SMS Message.<message>

[symbol]

[symbol]

</soapenv:Envelope>

As noted above, it will be seen that the SOAP command (which in this case relates to the sending of an SMS) includes a considerable amount of information which is not required simply to decide whether the user is authorised or not, to send an SMS message.

The relevant portions of the SOAP call for authentication purposes are marked in bold and italics with underlining.

As the SOAP procedure call passes through the proxy 8, a filtering function 10 co-operates with the proxy 8 to extract the XML fragments related to the SMS sending message and compares the username's permissions with the requested operation.

Unless the user is permitted to send an SMS message, the proxy is not permitted to forward the SOAP procedure call to the gateway 6 thus preventing the activity taking place.

In this way, the network operator may be given very fine control over the telecommunications facilities and functions which are made available to each user.

It will also be appreciated that this functionality does not require full parsing of the procedure call because XPath or XQuery type operations are performed on the document. Furthermore, the gateways 6 do not need to be adapted in order to provide this authentication feature.

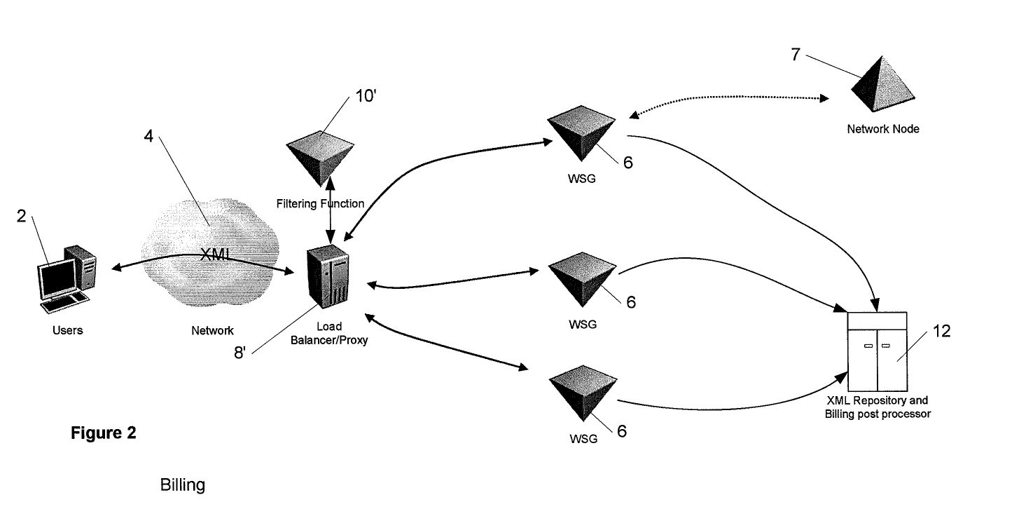

In a similar way, and with reference to FIG. 2, the proxy 8′ may co-operate with a filtering function 10′ to extract information from XML procedure calls which relate to chargeable events. Again, taking the example above of the sending of an SMS message, the filtering and billing function 10′ may record that an SMS message is being sent and add a charge to the user's account accordingly. Again, the procedure call is analysed using XPath or XQuery operations.

As an alternative, off-line billing may be carried out. In this case the gateways 6 pass XML procedure calls to a repository 12 which periodically analyses the procedure calls to add chargeable items to a user's account. Again, the use of queries such as XPath or XQuery allow the XML procedures to be analysed at much lower cost than a full parse of the whole procedure call.

In this way, the gateways 6 do not need modifying, for example by adding standard telecoms billing formats such as CDR, or AMA.

As noted above, generally, the XML messages will flow from the user to the gateway 6. However, the invention encompasses the idea of analysing return messages in the same way using XPath or XQuery type operations.

What is claimed is:

1. Monitoring apparatus for a telecommunications network including XML query means arranged to extract predetermined fragments of data from XML procedure calls passing through the network and processing means arranged to take action based on the extracted data fragments.

2. Apparatus according to claim 1 including billing means responsive to the processing means to generate billing charges dependent on chargeable activity in the network as determined by the extracted data fragments.

3. Apparatus according to claim 2, including an XML procedure call proxy wherein the fragments are extracted by proxying the XML procedure calls and performing extraction in the proxy.

4. Apparatus according to claim 2, including an XML repository which stores XML procedure calls which have been acted on and wherein the repository is arranged to perform the extraction and billing analysis.

5. Apparatus according to claim 1 including a user database arranged to hold user records and to map the user records against permitted XML procedure call fragments and further including authentication means which is arranged to compare the said extracted fragments with fragments in the user database to determine whether a user is permitted to carry out an operation and to block XML procedure calls which are not permitted for a user.

6. A method of monitoring activity in a telecommunications network comprising processing XML procedure calls flowing in the network and analysing only fragments of the procedure call using an XPath or XQuery operation.

7. A method according to claim 6 wherein the XML calls are intercepted and analysed before reaching their intended destination.

8. A method according to claim 7 including blocking an XML procedure call if the analysis determines that a user does not have permission to issue the procedure call.

9. A method according to claim 6 wherein the fragment analysis is used to determine whether chargeable activity is occurring for a network user and to generate a billing record responsively to that determination.

10. A telecommunications network including service provision means arranged to communicate using XML procedure calls, a user database containing details of users authorised to issue XML procedure calls to the service provision means and query means arranged to query the XML procedure calls to obtain data or text fragment from the procedure calls and comparison means to compare XML procedure calls with authorised procedure calls for particular users.

11. A telecommunications network including service provision means arranged to communicate using XML procedure calls, a billing database containing details of charges for users and query means arranged to query the XML procedure calls to obtain data or text fragment from the procedure calls and comparison means to compare XML procedure calls with chargeable procedure calls for particular users and to update the billing database responsively.

12. A computer program which when executed on a suitable telecommunications network node causes the node to monitor activity in the telecommunications network by processing XML procedure calls flowing in the network and analysing only fragments of the procedure call using an XPath or XQuery operation.
